(19) United States
(12) Patent Application Publication
(10) Pub. No.: US 2019/0063011 A1
(43) Pub. Date: Feb. 28, 2019

(54) COMBINATION PAVEMENT CUTTING AND DEBRIS REMOVAL DEVICE

(71) Applicant: DEREK NICHOLAS PLANAVSKY, NATRONA HEIGHTS, PA (US)

(72) Inventor: DEREK NICHOLAS PLANAVSKY, NATRONA HEIGHTS, PA (US)

(21) Appl. No.: 16/109,650

(22) Filed: Aug. 22, 2018

Related U.S. Application Data
(60) Provisional application No. 62/548,535, filed on Aug. 22, 2017.

(51) Int. Cl. E01C 23/09; B28D 1/04

(52) U.S. Cl. CPC E01C 23/0933; E01C 2301/50; B28D 1/047

(57) ABSTRACT

The present invention is an all-in-one pavement cutting and debris removal system, which comprises a cutting assembly including a saw blade and motor for supporting and rotating the saw blade, a water supply assembly that sends water to the saw blade including a water tank and water tube to keep the saw blade cool during cutting, and an assembly for removing the cutting debris/slurry created during the cutting. The assembly may utilize a high-pressure air flow or water to blow away the cement/water debris or a high vacuum suction device to vacuum away the cement/water debris. The present system employs a single truck to carry or tow the cutting assembly, water tank and air compressor for the same function that currently requires two trucks.

### REFERENCE TO RELATED APPLICATIONS

This patent application claims the benefit of U.S. Provisional Application No. 62/548,535 filed on Aug. 22, 2017, the disclosure of which is incorporated herein by reference in its entirety.

### BACKGROUND OF THE INVENTION

### Field of the Invention

This invention relates generally to saws and sawing equipment of the type used for cutting grooves into material such as concrete pavement and the like. More particularly, this invention relates to an improved concrete cutting system that has extra ability to remove concrete cutting debris/slurry at the same time.

### Description of Related Art

Equipment for cutting grooves into material such as concrete pavement and the like is known in the prior art. More specifically, by way of example, U.S. Pat. No. 4,832,412 to Bertrand discloses a powered truck-like vehicle having a support base at the back and an apparatus for cutting street or road pavement. A length-wise-extensible boom is mounted at one end on the base so that it can extend laterally from the vehicle. An elongated rail structure is mounted on the other end of the boom in a manner such that it can be moved alongside the boom. A saw carrier, mounted on the rail structure so that it can be displaced along it, is provided with a rotary pavement cutting saw that can be displaced relative to the rail structure to cut pavement.

U.S. Pat. No. 5,354,147 to Swisher, Jr. discloses a pulverizing machine with a cutter assembly adapted to be towed when the machine is moving either forward or in reverse. The machine includes a frame, a plurality of wheels supporting the frame, a cutter assembly carried by the frame and a pair of elevation cylinders for raising and lowering the cutter assembly. The cutter assembly has a cutter housing a cutter drum rotatably mounted within the cutter housing. The cutter housing is pivotally suspended from the frame by a pair of chain cases, one on each side. Each chain case contains a chain drive assembly connected to the cutter drum to drive the rotation of the cutter drum. Cutter teeth extend from the cutter drum to pulverize material as the cutter drum is lowered and rotated into the material.

U.S. Pat. No. 5,724,956 to Ketterhagen discloses a rideable power saw for cutting concrete. The saw includes a seat for supporting the rider and a mechanical steering assembly for manipulating the position of a rear drive wheel which is powered by a hydraulic motor. The saw also includes a blade drive mechanism for supporting and rotating the rotary saw blade. The saw blade is powered for rotation by a hydraulic motor and the blade drive mechanism includes a hydraulic cylinder for raising and lowering the position of the cutting blade without altering the position of the main platform of the saw.

None of the aforementioned inventions recognize and/or address the problem of reducing the temperature of the cutting equipment during use. None of the aforementioned inventions provide a solution for removing the concrete debris/slurry created during cutting. In accordance with one currently practiced process, the concrete debris/slurry is manually removed by construction personnel. One technique for removing the debris/slurry is through the use of an air compressor which is towed by another truck following behind the cutting equipment to blow away the cement debris. FIGS. 1 and 2 illustrate one currently used process for cutting cement lines in new roads and removing the debris/slurry. In this process, the first truck has a water supply that is sent to the saw that is used to cut the cement and requires at least one worker to operate the saw and the water supply. Then a second truck follows behind the first truck and includes an air tube and an air pressure source and requires at least a second operator to blow away the cuttings that the first truck created during the cutting process. Additional personnel are often provided to help with the removal the debris/slurry. Not only does this process require two trucks, it also requires at least two or even more people to operate the equipment.

The currently used process, involving two trucks and at least two operators, is cumbersome and expensive. Hence, it is desirable to have a system that simplifies this process by combining two trucks into one truck and eliminates the need for two separate operators. According to one embodiment, the same truck can carry both the cutting equipment and a water supply and can tow a large air compressor behind it. According to another embodiment, the same truck can carry a water supply and a large air compressor and tow the cutting equipment behind it. According to another embodiment, the same truck can carry a water supply and a large air compressor, which is driven behind a separately operated riding or push concrete saw. According to yet another embodiment, the same truck can carry a water supply and tow the cutting equipment behind it. Overall, a system that eliminates the need for two trucks and two operators to both cut the concrete and remove the concrete debris/slurry would be desirable.

### SUMMARY OF THE INVENTION

In an exemplary embodiment of the present invention, there is disclosed a concrete pavement cutting system and/or device, which comprises a concrete cutting assembly including a saw blade and motor connected to the saw blade for supporting and rotating the saw blade; a water supply assembly that sends water to the saw blade including a water tank; and a water tube having its upper end adapted to connect to the water tank and having its lower end disposed in the proximity of the saw blade for releasing water to cool the saw blade during cutting; and a cutting debris/slurry removing assembly to remove the concrete debris/slurry created by the concrete cutting assembly.

The cutting debris/slurry removing system and/or device may include an air compressor and/or a motorized pressure washer assembly; an air and/or water tube having its upper end adapted to connect to the air compressor and/or motorized pressure washer assembly; a secondary pressure building device connected to the downstream of the air tube and controlled by a valve to create higher air pressure; and an air/water pressure release tube having its upper end connected to the downstream of the secondary pressure building device and having its lower end disposed in the proximity of and behind the saw blade for releasing high pressure air/water to blow away the cuttings created by the saw blade.

In another embodiment, instead of blowing out air using the air compressor and secondary pressure building device, the system utilizes high vacuum suction device to draw in the left-over surface cutting debris/slurry.

In another embodiment, the cutting debris/slurry removing system and/or device may be used in combination with the high vacuum suction device to remove debris/slurry from the groove and draw in the left-over surface cutting debris/slurry.

The system and/or device may be mounted on a wheeled support frame and towed by a motor vehicle which carries the water tank and air compressor or high vacuum suction device in one embodiment.

In another embodiment, the system and/or device may be mounted on a truck-like vehicle and is able to extend laterally from the truck. The water tank and or air compressor or high vacuum suction device may be mounted on the same truck-like vehicle or carried in a trailer and towed by the truck-like vehicle equipped with the cutting assembly.

In another embodiment, the hose supplying the cooling water can be split by a diverter and/or a pressure washer motor assembly can be provided so that some of the cooling water can be used to assist in the debris/slurry removal. Alternatively, a separate hose can be supplied to spray water or even pressurized air at an angle onto the concrete to remove the debris/slurry.

In yet another embodiment, the system and/device can be mounted to a motor vehicle to remove debris/slurry. A water hose, supplying water, may attach to the system and/or device.

It can be appreciated that the slurry removing system, including the air compressor and/or a motorized pressure washer assembly; air and/or water tube, secondary pressure building device, and the air and/or water pressure release tube can be retrofitted to an existing concrete cutting device. It can also be appreciated that the pressure washer motor assembly or an additional pressurized air assembly can be retrofitted to an existing concrete cutting device.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 illustrates a method of cutting cement lines and removing debris/slurry in new roads in accordance with the prior art which requires two trucks.

FIG. 2 illustrates the method of cutting cement grooves and removing debris/slurry in new roads in accordance with the prior art as shown in FIG. 1 including construction personnel for operating the equipment.

FIG. 3 is a perspective view of a system for cutting pavement concrete and removing debris/slurry in accordance with one embodiment of the present invention which includes a separately operated pushing concrete saw together with a water tank and/or air compressor, all of which that are carried in a truck.

FIG. 4 is a perspective view of a system for cutting pavement concrete and removing debris/slurry in accordance with another embodiment of the present invention which includes a separately operated riding concrete saw together with a water tank and/or air compressor that are carried in a truck.

FIG. 5 is a perspective view of a system for cutting pavement concrete and removing debris/slurry in accordance with another embodiment of the present invention which includes a trailer equipped with a cutting assembly and towed by a truck that carries a water tank and air compressor thereon.

FIG. 6 is a perspective view of a system for cutting pavement concrete and removing debris/slurry in accordance with another embodiment of the present invention which includes a trailer equipped with a cutting assembly and towed by a truck that carries a water tank and high vacuum suction device thereon.

FIG. 7 is a schematic view of a system for cutting pavement concrete and removing debris/slurry in accordance with another embodiment of the present invention which includes a truck equipped with a cutting assembly which can be extended laterally, a water tank, and an air compressor thereon.

FIG. 8 is a perspective view of a system for cutting pavement concrete and removing debris/slurry in accordance with another embodiment of the present invention which includes a separate motorized pressure washer assembly mounted to the frame to assist in the removal debris/slurry.

FIG. 9 is perspective view of a diverter connected to the saw housing, which can be used in combination with any of the systems shown in FIGS. 3-8, wherein the diverter is secured to the water hose for diverting some of the water to assist in the removal of debris/slurry.

FIG. 10 is perspective view of the diverter of FIG. 9 in accordance with an embodiment of the invention.

FIG. 11 is a perspective view of a system and/or device for removing debris or slurry which can be mounted on a motor vehicle in accordance with another embodiment of the present invention.

### DRAWING REFERENCE NUMERALS

| | |
|---|---|
| 1. | blade |
| 2. | motor |
| 3. | water tank/source |
| 4. | water hose |
| 5. | one end of hose |
| 6. | opposite end of hose |
| 7. | air compressor |
| 8. | air tube |
| 9. | one end |
| 10. | opposite end |
| 11. | secondary pressure building device |
| 12. | air pressure release tube |
| 13. | upper end |
| 14. | lower end |
| 16. | wheeled support frame |
| 17. | handles |
| 18. | motor vehicle |
| 21. | high vacuum suction device |
| 22. | housing |
| 23. | hose attachment |
| 24. | mounting brackets |
| 25. | tow bar |
| 26. | hook |
| 27. | steering wheel |
| 28. | seat |
| 30. | motorized pressure washer assembly |
| 32. | hose |
| 34. | power connection |
| 36. | one end of hose |
| 37. | opposite end of hose |
| 38. | valve |
| 50. | diverter |
| 200. | system |
| 201. | truck-like vehicle |
| 202. | support base |
| 203. | apparatus for cutting |
| 204. | extension boom |
| 205. | elongated rail |
| 206. | saw carrier |
| 207. | cutting saw |
| 208. | mounting brackets |
| 209. | water tank |
| 210. | water hose |
| 211. | large air compressor |
| 212. | air tube |
| 213. | terminal notch |
| 300. | system |

### DESCRIPTION OF THE INVENTION

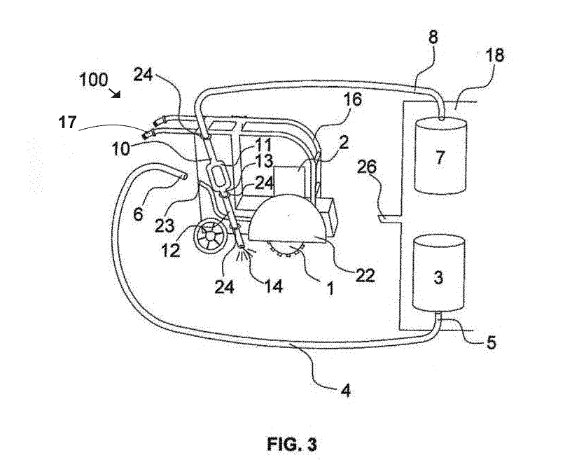

Referring to FIG. 3, there is disclosed an improved system, generally indicated as 100, for cutting concrete and similar materials and removing the debris/slurry according to one embodiment of the present invention. As shown the system 100 comprise a cutting assembly for cutting concrete, cement, and similar materials. The cutting assembly comprises a concrete saw blade 1 that is used to cut the concrete, and a motor 2 for the saw blade 1 connected to the saw blade for supporting and rotating the saw blade 1. The cutting assembly also has a housing 22 to shield part of the saw blade 1. The saw blade 1 can be used to cut grooves in a variety of materials including concrete, cement, and similar materials. The saw blade 1 is retractable through various mechanisms, including but not limited to, a hydraulic cylinder for raising and lowering the position of the saw blade 1. The motor 2 for powering the saw blade 1 includes, but is not limited to, one of electric motor, gas motor, hydraulic motor, and the like.

In order to keep the saw blade 1 cool during cutting, the system 100 further comprises a water supply assembly that sends water to the saw blade 1. The water supply assembly comprises a water tank 3 and a water hose 4. One end 5 of the water hose 4 is associated with the water tank 3 and the other or opposite end 6 is associated with the hose attachment 23 connected to the housing 22. In a stowed position, the water tank 3 and water hose 4 are detached from the cutting assembly. In operation, the water hose 4 is attached to the water tank 3 and to the hose attachment 23 for releasing water to keep the saw blade 1 cool and to decrease dust during cutting. The system 100 further comprises an assembly to remove concrete debris and slurry created during cutting.

In one embodiment, the assembly used to remove concrete debris and slurry is an air supply assembly which provides air pressure to blow away the concrete debris and slurry created by the wet cutting. The air supply assembly comprises an air compressor 7 and an air tube 8 having one end 9 adapted to connect to the air compressor 7 and another or opposite end 10 adapted to connect to a secondary pressure building device 11. The secondary pressure building device 11 is used to direct air pressure and/or create higher air pressure to blow away the concrete debris and slurry created by the saw blade through an air pressure release tube 12 which is connected downstream of the secondary pressure building device 11 via upper end 13. The secondary pressure building device 11 allows for an increase in the PSI or build-up of pressure from the air tube 8 that starts from the air compressor 7. The air pressure release tube 12 has a lower end 14 that is disposed in the proximity of and behind the saw blade 1 so that it can release high pressure air to immediately blow away the concrete debris and slurry during cutting.

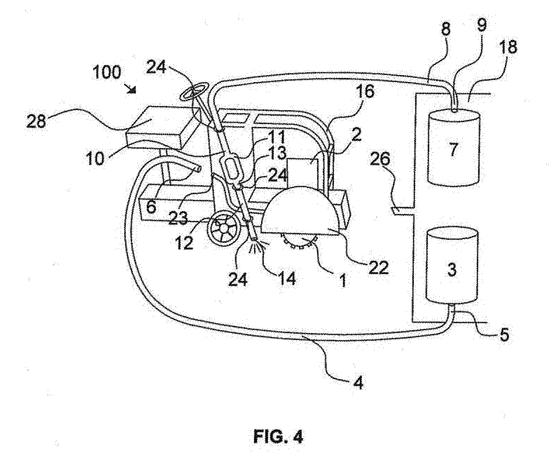

The system 100 further comprises a wheeled support frame 16 to support the cutting assembly. The saw blade 1 may be located on one of the sides of the wheeled support frame as shown in FIG. 3. It can be appreciated that the saw blade 1 can be located on either side of the wheeled support frame, i.e. either the left or the right. Alternatively, the saw blade 1 can be located in the center of the front end or the rear end of the wheeled support frame 16. The wheeled support frame 16 can include a pair of handles 17 for pushing the wheeled support frame 16. In the embodiment of FIG. 4, which shows a separately operating riding concrete saw, the wheeled support frame 16 may further comprise steering wheel 27 or seat 28.

The detailed construction and operation of the cutting assembly is known in the art. The disclosure of U.S. Pat. No. 5,354,147 to Swisher, Jr. is incorporated herein for reference.

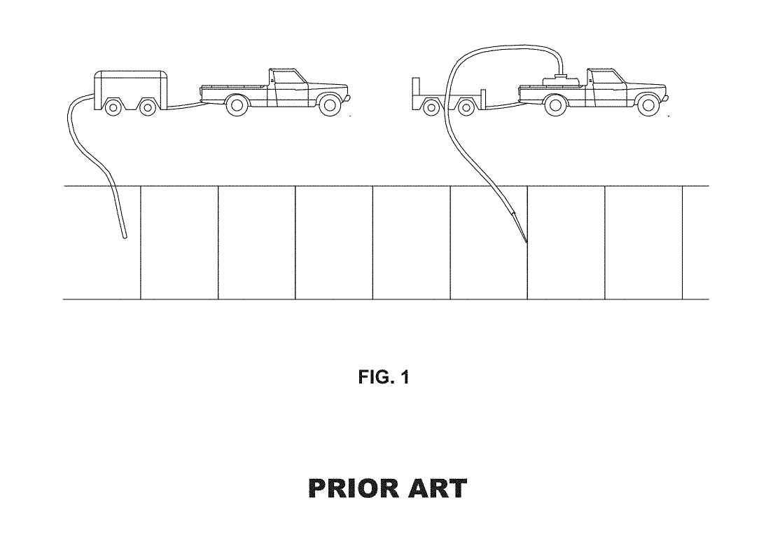

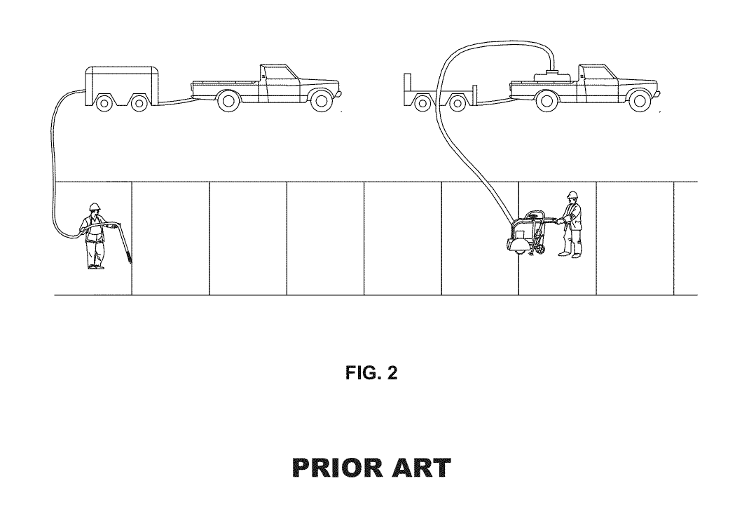

With continuing reference to FIGS. 3 and 4, the system 100 is different from the currently available riding concrete saw or pushing concrete saw, such as shown in FIGS. 1 and 2, in that the system 100 includes the assemblies to cool the saw blade and remove cutting debris and slurry during cutting. The wheeled support frame 16 is further equipped with water hose attachment 23, air tube 8, secondary air pressure building device 11, and air pressure release tube 12 which are all secured to the wheeled support frame 16 by mounting brackets 24.

The system further comprises a motor vehicle generally indicated as 18, such as a truck, to carry water tank 3 and the air compressor 7 as shown in FIGS. 3 and 4. Before operation, the water hose 4 is connected to the hose attachment 23 in the wheeled support frame 16 and to the water tank 3 on the truck 18. The air tube 8 connected to the wheeled support frame 16, such as by mounting brackets 24, is connected to the air compressor 7 on the truck 18. In operation, the construction worker drives or pushes the wheeled support frame 16 to cut the concrete pavement; meanwhile, water from the water tank 3 is sprayed during cutting to cool the saw 1 and the high-pressure air released from the air compressor 7 blows away the cutting debris and slurry.

It can be appreciated that, the air compressor 7 may be carried by a trailer or be towed by the truck 18.

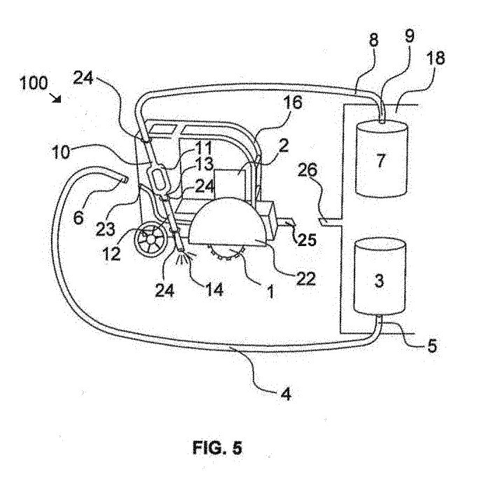

Referring now to FIG. 5, another embodiment, the wheeled support frame 16 can be an unpowered vehicle like a trailer which can be towed by a powered vehicle like a truck.

The system utilizes a truck 18 to tow the wheeled support frame 16 which equipped with the cutting assembly to engage cutting. Meanwhile, the same motor vehicle 18 carries the water tank 3 and the air compressor 7. The water hose 4 hooked to the wheeled support frame 16 is connected to the water tank 3 to spray water to cool the saw blade and the air tube 8 hooked to the wheeled support frame 16 is connected to the air compressor 7 to remove the debris/slurry created by the saw blade during cutting.

With continuing reference to FIG. 5, it is paramount that the wheeled support frame towed by the truck is secured to the truck so that the cutting is straight. The technology known in the art of trailer connections can be adopted. According to one example, a close-coupled trailer can be fitted with a rigid tow bar 25 which projects from its front and hooks onto a hook 26 on the truck 18 to ensure that the trailer does not pivot.

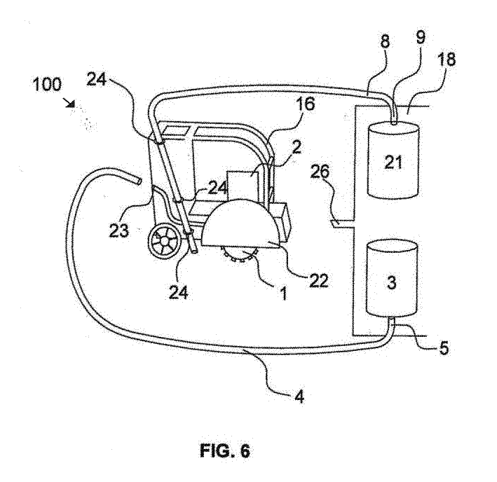

Reference is now made to FIG. 6, which shows another embodiment of the invention. In this system, a high vacuum suction device 21 is employed to assist in the removal of the surface debris/slurry by drawing in the concrete debris and slurry created during cutting and essentially prevent any runoff of the debris and slurry onto the surface of the concrete. The vacuum suction device 21 can be mounted on truck 18. It can be appreciated that the vacuum system can be used in conjunction with the cutting and debris removal device of the invention. Overall, this system also eliminates the need for two trucks to do this function.

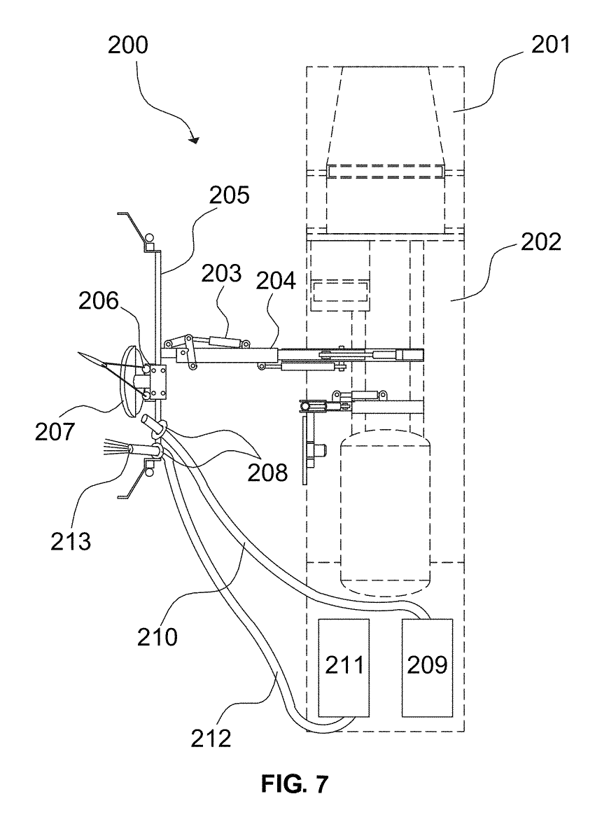

Referring to FIG. 7 there is disclosed another embodiment of the present invention. The system 200 of the present invention comprises a powered truck-like vehicle 201 having a support base 202 at a back portion and an apparatus 203 for cutting street or road pavement. A length-wise-extensible boom 204 is mounted at one end on the base 202 so that it can extend laterally of the vehicle 201. An elongated rail structure 205 is mounted on the other end of the boom in a manner such that it can be moved alongside the boom 204. A saw carrier 206, mounted on the rail structure 205 so that it can be displaced along it, is provided with a rotary pavement cutting saw 207 that can be displaced relative to the rail structure 205 to cut pavement. The disclosure of U.S. Pat. No. 4,832,412 to Bertrand is incorporated herein by reference in its entirety.

Further, a plurality of mounting brackets 208 are located on the rail structure 205 for securing water hose 210 and air tube 212 which will be discussed below.

Further, a water supply assembly including a water tank 209 and the water hose 210 may be mounted on the truck-like vehicle 201 that is equipped with the cutting assembly as shown in FIG. 7 or carried by a trailer (not shown in the figure) and towed by the truck-like vehicle 201. The water hose 210 has one, upstream end connected to the water tank 209 and an opposite, downstream end located adjacent to the saw blade 207. This downstream end of the water hose 210 is hooked to the elongated rail structure 205 by the mounting bracket 208. During operation the water hose 210 supplies water to keep the saw blade 207 cool and decrease dust during cutting.

The system further comprises an air supply assembly including a large air compressor 211 and an air tube 212. In operation, the large air compressor 211 may be carried in the same truck-like vehicle 201 as shown in FIG. 7 or towed in a trailer (not shown in the figure) by the same truck-like vehicle that is equipped with the cutting assembly. One end of the air tube 212 is connected to the air compressor 211 and the other end is attached to the elongated rail structure 205 by the mounting bracket 208. The terminal notch 213 of the air tube 212 is disposed in the proximity of the saw blade 207 and behind the saw blade so that the air emitted from the air tube 212 can blow away the concrete debris and slurry during cutting. There may be a secondary pressure building device, such as described above in relation to FIG. 3, added to the downstream of the air compressor to build higher pressure than the pressure directly from air compressor 211. It can be appreciated that the air compressor and secondary pressure building device can be replaced with a high vacuum suction device, such as shown in FIG. 6, to draw in the left-over cement/water debris.

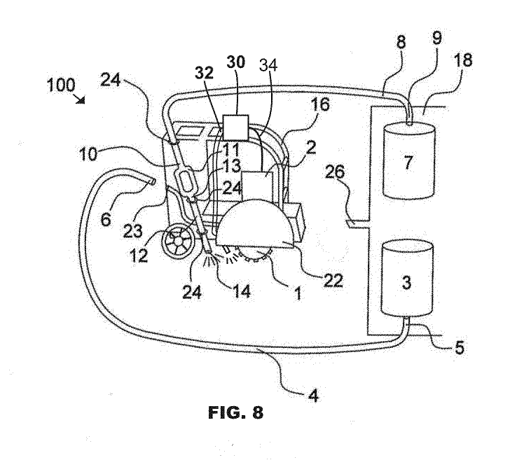

Reference is now made to FIG. 8, which shows a motorized pressure washer assembly 30 that can be mounted to the support frame 16. At least one separate hose 32 can have an end associated with the pressure washer motor 30 and an opposite end extending at an angle (i.e. between 0-90°, between 30-60°, or approximately 45°) with respect to the pavement, as the device moves in a forward direction, to assist in removing debris/slurry. The hose 32 can be mounted anywhere on the support frame 16 as long as the opposite end of the spray nozzle, from which water exits, is properly positioned to remove the debris/slurry from the surface after cutting. The pressure washing assembly 30 includes a motor which can include a power connection 34 so that the washing motor draws its power from the saw battery or saw motor 2. An inverter can be provided to convert direct current power to alternating current power. It can be appreciated that other power sources can be used to supply energy to the pressure washing motor including generators, air compressors, gas, electricity, battery, and the like. It can be appreciated that more than one hose 32 can be utilized and that the hose 32 can be used in conjunction with a splitter or diverter on the hose 32 itself, or in conjunction with a splitter or diverter on the water hose 4, as discussed in detail below, depending upon the amount of surface area that needs to be cleaned.

In a further embodiment, a pressurized air tube and/or air source could be provided to assist the air compressor 1, air tube 8, and secondary pressure building device 11 in the debris/slurry removal. This pressurized air tube/source can be powered in the same way as the pressure washing assembly 30, discussed above, i.e. self-powered by the saw motor or externally powered by the various systems set forth above and well-known in the art.

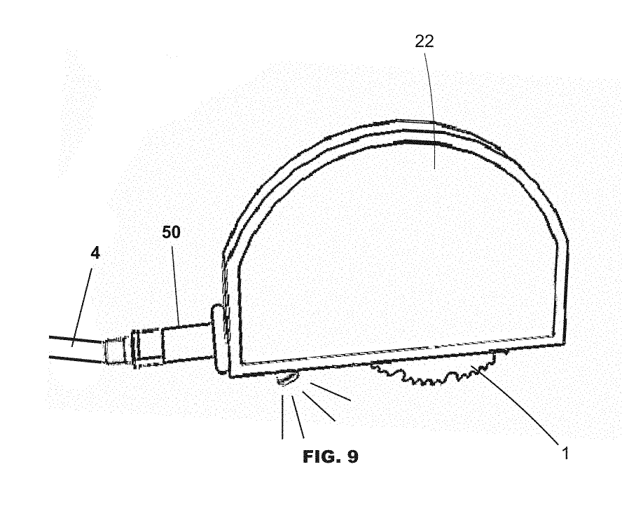

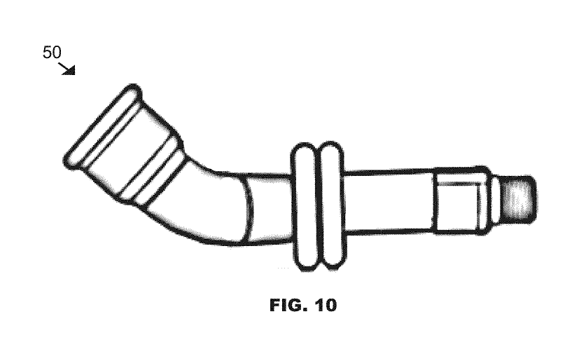

Alternatively, a splitter or diverter, generally indicated as 50, as shown in FIGS. 9 and 10 can be provided on the water hose 4 to divert some of the saw cooling water such that the water flows at an angle with respect to the ground/concrete surface to assist with the removal of the debris/slurry. It can be appreciated that the second water hose can be angled at any angle less than 90°, such as from 30-60° or approximately 45° with respect to the ground/concrete so as to effectively remove the debris/slurry.

In the designs set forth above that include a pressure washer assembly 30, a pressurized air/water source, or a splitter/diverter 50 on the water hose 4, a flap (not shown) can be provided inside the housing 22 of the saw blade 1. This flap can be located in front of the jet stream, which is being used to assist in the removal of debris/slurry, and behind the saw blade 1 to isolate the cooling water.

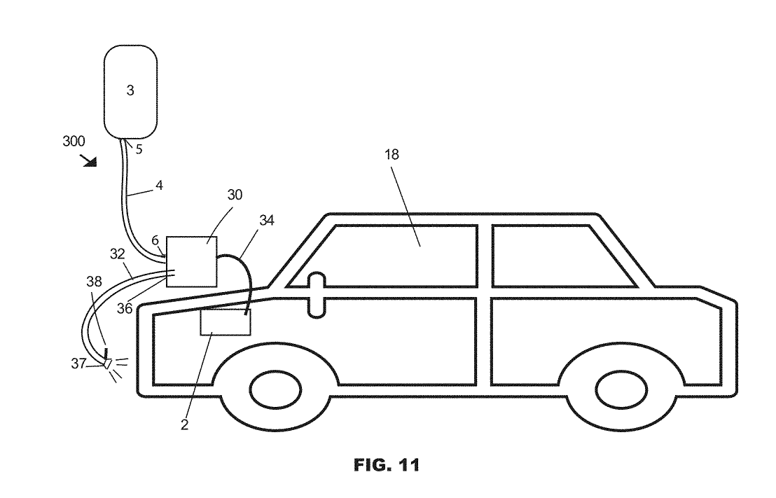

Reference is now made to FIG. 11, which shows another embodiment of the present invention. The system 300 of the present invention can be mounted anywhere on a motor vehicle 18 for debris or slurry removal. Alternatively, the system 300 can be mounted inside the motor vehicle. The system 300 can have a water supply assembly. The water assembly comprises of an external water source 3 and/or an additional water source and a hose 4. One end 5 of the water hose 4 is associated with the water source 3 and the other or opposite end 6 is connected to the motorized pressure washer assembly 30. At least one separate hose 32 can have an end 36 associated with the motorized pressure washer 30 and an opposite end 37 that can be adapted to release pressurized water to remove debris. A valve 38 to control water pressure can be associated with hose 32. The system 300 of the present invention comprises a motorized pressure washer assembly 30 which includes a motor and can include a power connection 34 so that the washing motor draws its power from the battery or dual port alternator or motor 2 of the motor vehicle or an additional power source. An inverter can be provided to convert direct current power to alternating current power. It can be appreciated that other power sources can be used to supply energy to the pressure washing motor including generators, air compressors, gas, electricity, battery, and the like. It can be appreciated that more than one hose 32 can be utilized and that the hose 32 can be used in conjunction adapters on the hose 32 itself to clean debris or slurry from surface areas. It can be appreciated that an external water source or an additional water source may be used. It can be appreciated that the system 300 can be used on any motor vehicle for removal of debris or slurry from surface areas, objects, materials, and the like.

It can be appreciated that any or all of the embodiments disclosed above can be used to retrofit an existing or current pavement cutting system so as to convert these two truck systems into a single or combination, all-in-one device for cutting and removing the debris/slurry.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for cutting materials and removing debris/slurry, comprising:
a cutting assembly for cutting grooves into the materials, comprising:
a saw blade;
a saw blade motor connected to the saw blade for supporting and rotating the saw blade; and
a water supply assembly that supplies water to the saw blade, comprising:
a water tank; and
a water hose having its one end adapted to connect to the water tank and having an opposite end adapted to connect to a hose attachment associated with the cutting assembly;
an assembly to remove cutting debris/slurry; and
a wheeled support frame to support the cutting assembly and water hose.

2. The system of claim 1, wherein the wheeled support frame has a front end, a rear end, two sides, and a plurality of brackets.

3. The system of claim 1, wherein the assembly to remove cutting debris/slurry comprises:
an air compressor;
an air tube having one end adapted to detachably connect to the air compressor;
a secondary pressure building device detachably connected to the other end of the air tube and controlled by a valve to create a higher air pressure; and
an air pressure release tube having its upper end detachably connected to the downstream of the secondary pressure building device and having its lower end disposed behind the saw blade for releasing high pressure air to blow away the cutting debris/slurry created during cutting;
wherein the secondary pressure building device mounted on and secured to the wheeled support frame via mounting brackets.

4. The system of claim 1, wherein the assembly to remove cutting debris/slurry comprises:
a high vacuum suction device; and
air tubes.

5. The system of claim 3, wherein the saw blade is disposed on one of the two sides of the wheeled support frame.

6. The system of claim 5, further comprising a motor vehicle that carries the water tank and air compressor.

7. The system of claim 6, wherein the motor vehicle tows the wheeled support frame which is equipped with the cutting assembly and the secondary pressure building device thereon.

8. The system of claim 6, wherein the wheeled support frame equipped with the cutting assembly and the secondary pressure building device thereon further comprises an engine to drive the wheeled support frame and a seat for supporting a rider.

9. The system of claim 6, wherein the wheeled support frame equipped with the cutting assembly and the secondary pressure building device thereon further comprises handles for a worker to push.

10. The system of claim 8, wherein the saw blade is retractable.

11. The system of claim 1, wherein the saw blade is disposed in the center of the front end or the rear end of the wheeled support frame.

12. The system of claim 1, wherein the cutting assembly is adapted for cutting concrete or cement.

13. A system for cutting materials, comprising:
a vehicle having a support base and a cutting apparatus mounted on the base for cutting materials, the cutting apparatus comprising:
a rotary cutting saw;
a water supply assembly that sends water to the saw, comprising:
a water tank; and
a water tube having its upper end adapted to connect to the water tank and having its lower end disposed in the proximity of the saw for releasing water to cool the saw during cutting; and
a cutting debris/slurry removing assembly to remove the cutting debris/slurry created during cutting.

14. The system of claim 13, wherein the cutting apparatus further comprises: a lengthwise-extensible boom which is able to extend laterally thereof;
an elongated rail structure connected to the boom; and
a saw carrier connected to the rail structure;
wherein the rotary cutting saw is connected to the rail structure for cutting pavement.

15. The system of claim 14, wherein the cutting debris/slurry removing assembly comprises:
an air compressor; and
an air tube having its upper end adapted to connect to the air compressor and having its lower end disposed in the proximity of and behind the saw for releasing high pressure air to blow away the cutting debris/slurry created during cutting.

16. The system of claim 14, wherein the cutting debris/slurry removing assembly comprises:
a high vacuum suction device; and
air tubes.

17. The system of claim 14, wherein the water tank is mounted on the vehicle or carried by a trailer which is towed by the vehicle.

18. The system of claim 15, wherein the air compressor is mounted on the vehicle or a trailer which is towed by the vehicle.

19. The system of claim 16, wherein the high vacuum suction device is mounted on the vehicle or a trailer which is towed by the vehicle.

20. The system of claim 15, wherein the cutting debris/slurry removing assembly further comprises a secondary pressure building device connected to the downstream of the air compressor and controlled by a valve to create a higher air pressure.

21. The system of claim 13, wherein the cutting assembly is adapted for cutting concrete or cement.

22. The system of claim 1, including a pressure washer or pressurized air device associated with the support frame for assisting in the removal of debris/slurry.

23. The system of claim 13, including a pressure washer or pressurized air device associated with the support frame for assisting in the removal of debris/slurry.

24. A combination cutting and debris removal device, comprising:
a cutting assembly for cutting grooves into a surface, comprising:
a saw blade;
a saw blade motor connected to the saw blade for supporting and rotating the saw blade;
a water supply assembly for supplying water to the saw blade, an assembly to remove cutting debris/slurry; and
a support device for supporting the cutting assembly, water supply, and
debris/slurry removal assembly.

25. A method for retrofitting a concrete cutting device with a debris removal device comprising
providing a cutting assembly including a saw blade, a saw blade motor, and a water supply assembly for supplying cooling water to the saw blade, said cutting assembly being mounted onto a support device; and
providing a debris/slurry removal assembly for removing the debris/slurry created by the saw blade during cutting, said debris/slurry removal assembly comprising at least one of a pressurized air or pressurized water,
wherein the cutting assembly and debris/slurry removal assembly are mounted on the same support device.

26. A system for debris or slurry removal comprising:
a water supply assembly for supplying water to the debris or slurry removal assembly, comprising:
a water source; and
a water hose having its one end adapted to connect to the water tank or source and having its opposite end adapted to connect to a hose attachment associated with the debris or slurry removal device;
a debris or slurry removal assembly, comprising:
a motorized pressure washer assembly;
a water hose having one end adapted to connect to the assembly and having its opposite end adapted to release pressurized water to remove debris or slurry;
a valve to control water pressure;
a power source comprising at least one power source from a motor vehicle or an additional power source; and
a support device for supporting the debris or slurry removal assembly;
wherein the debris or slurry removal assembly is mounted on or in a motor vehicle.
